(19) United States
(12) Patent Application Publication
(10) Pub. No.: US 2023/0034336 A1
(43) Pub. Date: Feb. 2, 2023

(54) METHOD AND APPARATUS FOR SIDELINK POSITIONING IN WIRELESS COMMUNICATION SYSTEM

(71) Applicant: Samsung Electronics Co., Ltd., Suwon-si (KR)

(72) Inventors: Cheolkyu SHIN, Suwon-si (KR); Hyunseok RYU, Suwon-si (KR); Sungjin PARK, Suwon-si (KR); Seunghoon CHOI, Suwon-si (KR)

(21) Appl. No.: 17/873,069

(22) Filed: Jul. 25, 2022

(30) Foreign Application Priority Data
Jul. 26, 2021 (KR) 10-2021-0097977
May 6, 2022 (KR) 10-2022-0056171

(51) Int. Cl. H04W 4/02

(52) U.S. Cl. CPC H04W 4/023

(57) ABSTRACT

The disclosure relates to a 5G or pre-5G communication system for supporting a higher data transmission rate than a 4G communication system such as long-term evolution (LTE). A method performed by a first terminal in a wireless communication system supporting sidelink is provided. The method comprises receiving from at least one second terminal location information of the second terminal and reliability information for the location information of the second terminal, selecting at least one second terminal to be used for location measurement of the first terminal based on the reliability information, and determining a location of the first terminal based location information of at least one second terminal selected based on the reliability information.

### CROSS-REFERENCE TO RELATED APPLICATIONS

This application is based on and claims priority under 35 U.S.C. 119 to Korean Patent Application No. 10-2021-0097977 filed on Jul. 26, 2021 and Korean Patent Application No. 10-2022-0056171 filed on May 6, 2022 in the Korean Intellectual Property Office, the disclosures of which are herein incorporated by reference in their entirety.

### BACKGROUND

### 1. Field

The disclosure relates to a wireless communication system and, specifically, to a method and an apparatus for performing positioning through a sidelink.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems.

In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have also been developed.

### SUMMARY

The disclosure relates to a wireless communication system and, specifically, to a method and an apparatus for performing positioning through a sidelink. Specifically, a method for selecting, by a terminal, a terminal serving as a criterion of location measurement when positioning is performed through a sidelink is required.

The disclosure is to propose a method and a procedure for performing positioning through a sidelink by a terminal. Through the proposed method, it is possible to measure an accurate location in a sidelink.

In accordance with an aspect of the disclosure, a method performed by a first terminal in a wireless communication system supporting sidelink is provided. The method comprises receiving from at least one second terminal location information of the second terminal and reliability information for the location information of the second terminal, selecting at least one second terminal to be used for location measurement of the first terminal based on the reliability information, and determining a location of the first terminal based location information of at least one second terminal selected based on the reliability information.

In accordance with another aspect of the disclosure, a first terminal in a wireless communication system supporting sidelink is provided. The first terminal comprises a transceiver for transmitting and receiving a signal, and a controller configured to receive from at least one second terminal via the transceiver location information of the second terminal and reliability information for the location information of the second terminal, select at least one second terminal to be used for location measurement of the first terminal based on the reliability information, and determine a location of the first terminal based location information of at least one second terminal selected based on the reliability information.

In accordance with another aspect of the disclosure, a method performed by a second terminal in a wireless communication system supporting sidelink is provided. The method comprises generating reliability information for location information of the second terminal, and transmitting to a first terminal the location information of the second terminal and the reliability information.

In accordance with another aspect of the disclosure, a second terminal in a wireless communication system supporting sidelink is provided. The second terminal comprises, a transceiver for transmitting and receiving a signal; and a controller configured to generate reliability information for location information of the second terminal, and transmit to a first terminal via the transceiver the location information of the second terminal and the reliability information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system according to an embodiment;

FIG. 2A illustrates a communication method performed through a sidelink according to an embodiment and FIG. 2B illustrates a communication method performed through a sidelink according to an embodiment;

FIG. 3 illustrates a resource pool defined as a set of resources in time and frequency used for sidelink transmission and reception according to an embodiment;

FIG. 4 illustrates a case of calculating the location of a terminal through a sidelink according to an embodiment;

FIG. 5 illustrates a case of calculating the location of a terminal through a sidelink according to an embodiment;

FIG. 6 illustrates a case of calculating the location of a terminal through a sidelink according to an embodiment;

FIG. 7 illustrates a measurement source that is a reference terminal used for location measurement in a case of performing positioning through a sidelink by a target terminal according to an embodiment;

FIG. 8A illustrates a method for indicating reliability information to a target terminal through a sidelink by a terminal serving as a measurement source according to an embodiment, and FIG. 8B illustrates a method for indicating reliability information to a target terminal through a sidelink by a terminal serving as a measurement source according to an embodiment;

FIG. 9 illustrates a method for selecting a measurement source, based on a reception power measurement by a target terminal according to an embodiment;

FIG. 10 illustrates a method for selecting a measurement source through an NLOS identification by a target terminal according to an embodiment;

FIG. 11A illustrates a case in which a round trip time (RTT) is applied as a positioning measurement method according to an embodiment, and FIG. 11B illustrates a case in which a round trip time (RTT) is applied as a positioning measurement method according to an embodiment;

FIG. 12 illustrates a diagram, through an experiment result, of a performance when positioning is performed according to an embodiment;

FIG. 13 illustrates a block diagram showing an internal structure of a terminal according to an embodiment; and

FIG. 14 illustrates a block diagram showing an internal structure of a base station according to an embodiment.

### DETAILED DESCRIPTION

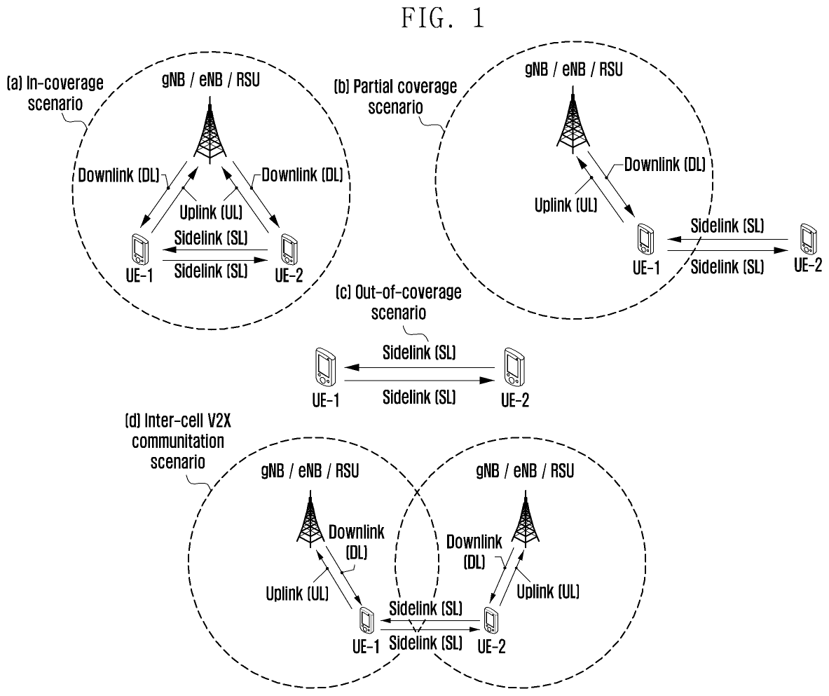

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

The following detailed description of embodiments of the disclosure is mainly directed to New RAN (NR) as a radio access network and Packet Core (5G system, 5G core network, or next generation core (NG Core)) as a core network, which are specified in the 5G mobile communication standards defined by the 3rd generation partnership project long term evolution (3GPP LTE) that is a mobile communication standardization group, but based on determinations by those skilled in the art, the main idea of the disclosure may be applied to other communication systems having similar backgrounds or channel types through some modifications without significantly departing from the scope of the disclosure.

In the 5G system, in order to support network automation, a network data collection and analysis function (NWDAF), which is a network function that provides a function to analyze and provide data collected from a 5G network, may be defined. The NWDAF may collect/store/analyze information from 5G networks and provide the results to unspecified network functions (NFs), and the analysis results may be used independently in each NF.

In the following description, some of terms and names defined in the 3GPP standards (standards for 5G, NR, LTE, or other similar systems) may be used for the convenience of description. However, the disclosure is not limited by these terms and names, and may be applied in the same way to systems that conform other standards.

Further, in the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

To meet the demand for wireless data traffic having increased since deployment of 4G communication systems, efforts have been made to develop improved 5G communication systems (new radio (NR)). The 5G communication systems have been designed to be supported also in ultrahigh frequency (mmWave) bands (e.g., 28 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are under discussion in the 5G communication systems. Further, unlike in the LTE, in the 5G communication systems, various subcarrier spacings including 15 kHz, such as 30 kHz, 60 kHz, and 120 kHz, are supported, physical control channels use polar coding, and physical data channels use low density parity check (LDPC). In addition, CP-OFDM, as well as DFT-S-OFDM, is also used as a waveform for uplink transmission. While the LTE supports transport block (TB)-based hybrid ARQ (HARQ) retransmission, the 5G can additionally support HARQ retransmission based on a code block group (CBG) which is a bundle of multiple code blocks (CBs).

In addition, in 5G communication systems, development for system network improvement is under way based on advanced small cells, cloud radio access networks (RANs), ultra-dense networks, device-to-device (D2D) communication, wireless backhaul, vehicle-to-everything (V2X) network, cooperative communication, coordinated multi-points (CoMP), reception-end interference cancellation and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology” “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology. As described above, a plurality of services may be provided to a user in a communication system, and in order to provide such a plurality of services to a user, a method for providing each service within the same time period according to the characteristics and an apparatus using the same are required. Various services provided in the 5G communication system are being studied, and one of the various services is a service that satisfies the requirements for low latency and high reliability. In particular, in the case of vehicle communication, the NR V2X system supports UE-to-UE unicast communication, groupcast (or multicast) communication, and broadcast communication. In addition, unlike LTE V2X, which aims to transmit and receive basic safety information necessary for road driving of vehicles, the NR V2X aims to provide more advanced services such as platooning, advanced driving, extended sensors, and remote driving.

Specifically, in NR sidelink, positioning may be performed through an inter-terminal sidelink. In other words, a method for measuring the location of a terminal by using a positioning signal transmitted through a sidelink may be considered. A conventional method for measuring the location of a terminal by using a positioning signal transmitted through a downlink and an uplink between a terminal and a base station is possible only in a case where the terminal is in the coverage of the base station. However, when sidelink positioning is introduced, measurement of the location of a terminal may be possible even when a terminal is out of the coverage of a base station. The disclosure proposes methods for selecting, by a terminal, a terminal serving as a criterion of location measurement when positioning is performed through a sidelink. In a case of conventional positioning performed through a downlink and an uplink between a terminal and a base station, a location server may provide information on a base station or a transmission reception point (TRP) serving as a criterion of location measurement. However, the location server may not be available in sidelink, and above all, location information provided by a terminal may be inaccurate due to the movement of the terminal. Therefore, in order to solve these problems, the disclosure proposes methods for selecting, by a terminal, a source suitable for location measurement in a sidelink.

An embodiment of this specification is proposed to support the above scenario and, specifically, an aspect thereof is to provide a method and an apparatus for measuring the location of a terminal in a sidelink.

FIG. 1 illustrates a system according to an embodiment.

In FIG. 1, scenario (a) shows an example of a case (In-Coverage, IC) where all terminals (UE-1 and UE-2) communicating through a sidelink communication are positioned within the coverage of a base station. All the terminals may receive data and control information from the base station through downlinks (DLs), or transmit data and control information to the base station through uplinks (ULs). The data and control information may be data and control information for sidelink communication. The data and control information may be data and control information for general cellular communication. In addition, the terminals may transmit/receive data and control information for corresponding communication through a sidelink (SL).

In FIG. 1, scenario (b) shows an example of a case where UE-1 among terminals is positioned within the coverage of a base station, and UE-2 is positioned out of the coverage of the base station. That is, scenario (b) of FIG. 1 shows an example related to a partial coverage (PC) indicating that some terminals (UE-2) are positioned out of the coverage of a base station. The terminal (UE-1) located in the coverage of the base station may receive data and control information from the base station through a downlink, or may transmit data and control information to the base station through an uplink. The terminal (UE-2) located out of the coverage of the base station is not able to receive data and control information from the base station through a downlink, and is not able to transmit data and control information to the base station through an uplink. In addition, the terminal (UE-2) and the terminal (UE-1) may transmit/receive data and control information for corresponding communication through a sidelink.

In FIG. 1, scenario (c) shows an example of a case where all terminals are positioned out of the coverage of a base station (out-of-coverage, OOC). Therefore, the terminals (UE-1 and UE-2) are not able to receive data and control information from a base station through a downlink, and are not able to transmit data and control information to the base station through an uplink. The terminals (UE-1 and UE-2) may transmit/receive data and control information through a sidelink.

In FIG. 1, scenario (d) shows an example of a scenario of performing sidelink communication between terminals (UE-1 and UE-2) positioned in different cells. Specifically, scenario (d) of FIG. 1 shows a case where the terminals (UE-1 and UE-2) are connected to (are in an RRC connection state) or are camping on (are in an RRC disconnection state, i.e., RRC idle state) different base stations. The terminal (UE-1) may be a transmission terminal in a sidelink, and the terminal (UE-2) may be a reception terminal. Alternatively, the terminal (UE-1) may be a reception terminal in a sidelink, and the terminal (UE-2) may be a transmission terminal. The terminal (UE-1) may receive a system information block (SIB) from a base station to which the terminal is connected (or on which the terminal is camping), and the terminal (UE-2) may receive an SIB from a different base station to which the terminal is connected (or on which the terminal is camping). The SIB, an existing SIB or an SIB separately defined for sidelink communication may be used. In addition, information of an SIB received by the terminal (UE-1) and information of an SIB received by the terminal (UE-2) may be different from each other. Therefore, in order to perform sidelink communication between the terminals (UE-1 and UE-2) positioned in different cells, a method for matching information, or signaling information therefor to analyze SIB information transmitted from a different cell may be additionally required.

In FIG. 1, for convenience of explanation, a sidelink system including two terminals (UE-1 and UE-2) has been illustrated, but the disclosure is not limited thereto, and communication between more terminals may be performed. In addition, an interface (uplink and downlink) between a base station and terminals may be called an Uu interface, and a sidelink communication between terminals may be called a PC5 interface. Therefore, in the disclosure, the above terms may be used together. A terminal in the disclosure may indicate a general terminal and a terminal supporting vehicle-to-everything (V2X). Specifically, a terminal in the disclosure may indicate a handset (e.g., a smartphone) of a pedestrian. Alternatively, a terminal may include a vehicle supporting vehicle-to-vehicle (V2V) communication, a vehicle supporting vehicle-to-pedestrian (V2P) communication, a vehicle supporting vehicle-to-network (V2N) communication, or a vehicle supporting vehicle-to-infrastructure (V21) communication. In addition, a terminal in the disclosure may include a roadside unit (RSU) equipped with a terminal function, an RSU equipped with a base station function, or an RSU equipped with a part of a base station function and a part of a terminal function. In addition, according to an embodiment, a base station may be a base station supporting both V2X communication and general cellular communication, or a base station supporting only V2X communication. The base station may be a 5G base station (gNB), a 4G base station (eNB), or an RSU. Therefore, in the disclosure, a base station may be called an RSU.

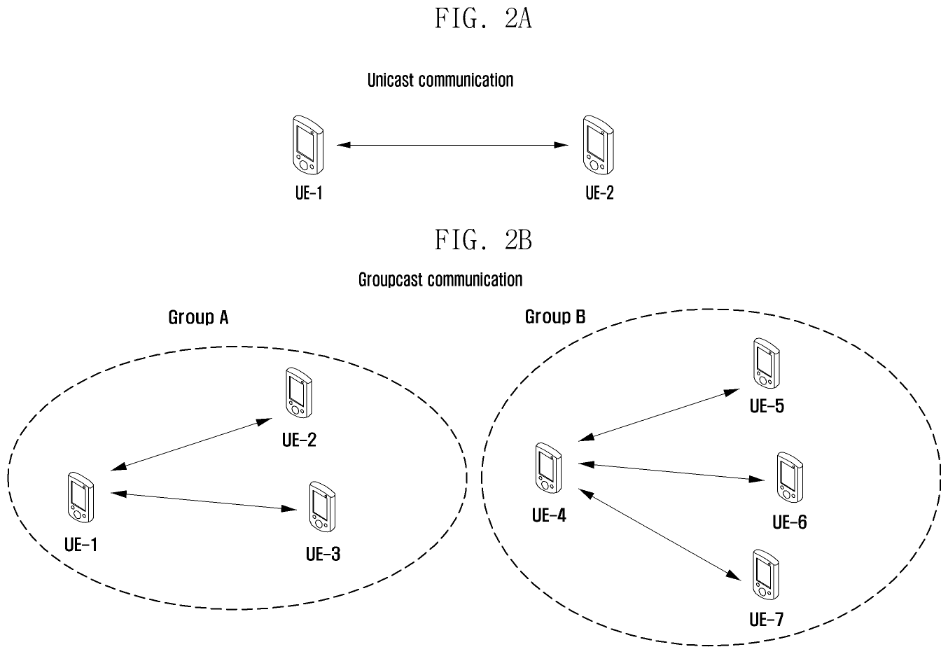

FIG. 2A illustrates a communication method performed through a sidelink according to an embodiment, and FIG. 2A illustrates a communication method performed through a sidelink according to an embodiment.

Referring to FIG. 2A, UE-1 (e.g., TX terminal) and UE-2 (e.g., RX terminal) may perform one-to-one communication, and this may be called unicast communication. In a sidelink, capability information and configuration information may be exchanged between terminals through a PC5-RRC defined in a unicast link between the terminals. In addition, configuration information may be exchanged through a sidelink medium access control (MAC) control element (CE) defined in a unicast link between the terminals.

Referring to FIG. 2B, a TX terminal and an RX terminal may perform one-to-multiple communication, and this may be called groupcast or multicast. In FIG. 2B, UE-1, UE-2, and UE-3 may configure one group (Group A) to perform groupcast communication, and UE-4, UE-5, UE-6, and UE-7 may configure another group (Group B) to perform groupcast communication. Each terminal may perform groupcast communication only in a group to which the terminal belongs, and communication between different groups may be performed through unicast, groupcast, or broadcast communication. In FIG. 2B, two groups (Group A and Group B) are illustrated, but the disclosure is not limited thereto.

Although not illustrated in FIGS. 2A and 2B, terminals may perform broadcast communication in a sidelink. The broadcast communication indicates a case where all other terminals receive data and control information transmitted through a sidelink by a transmission terminal. For example, when it is assumed that UE-1 is a transmission terminal for broadcast in FIG. 2B, all terminals (UE-2, UE-3, UE-4, UE-5, UE-6, and UE-7) may receive data and control information transmitted by UE-1.

In NR V2X, unlink LTE V2X, a type in which a vehicle terminal transmits data to only one particular node through unicast and a type in which a vehicle terminal transmits data to particular multiple nodes through groupcast may be considered to be supported. For example, unicast and groupcast technologies described above may be useful in a service scenario, such as platooning which is a technology in which two or more vehicles are connected to one network, and move while being bound in a group. Specifically, unicast communication may be needed for the purpose of allowing a leader node of a group connected by platooning, to control one particular node, and groupcast communication may be required for the purpose of controlling a group including particular multiple nodes at the same time.

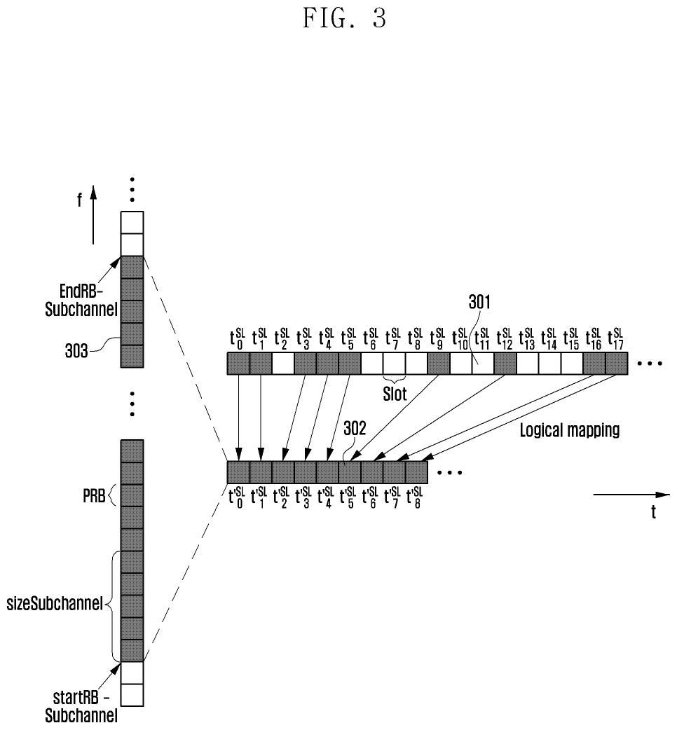

FIG. 3 illustrates a resource pool defined as a set of resources in time and frequency used for sidelink transmission and reception according to an embodiment. A resource allocation unit (resource granularity) on a time axis in a resource pool may be a slot. In addition, a resource allocation unit on a frequency axis may be a sub-channel configured by one or more physical resource blocks (PRBs). In the disclosure, a case where a resource pool has been discontinuously allocated in time is explained as an example, but a resource pool may also be continuously allocated in time. In addition, in the disclosure, a case where a resource pool has been continuously allocated in frequency is explained as an example, but a method in which a resource pool is discontinuously allocated in frequency is not excluded.

Referring to FIG. 3, a case 301 where a resource pool has been discontinuously allocated in time is illustrated. Referring to FIG. 3, a case where a unit (granularity) of resource allocation in time is a slot is illustrated. First, a sidelink slot may be defined in a slot used as an uplink. Specifically, the length of symbols used as a sidelink in one slot may be configured by sidelink bandwidth part (BWP) information. Therefore, slots in which the length of symbols configured as a sidelink is not secured among slots used as an uplink are not able to be sidelink slots. In addition, a slot in which a sidelink synchronization signal block (S-SSB) is transmitted is excluded from slots belonging to a resource pool. Referring to case 301, a set (t₀^{SL}, t₁^{SL}, t₂^{SL}, . . . ) of slots available for a sidelink in time except for the slots mentioned above is illustrated. The colored part in case 301 shows sidelink slots belonging to the resource pool. The sidelink slots belonging to the resource pool may be (pre-)configured through a bitmap by resource pool information. Referring to case 302, a set (t₀^{SL}, t₁^{SL}, t₂^{SL}, . . . ) of sidelink slots belonging to a resource pool in time is illustrated. In the disclosure, (pre-)configuration may indicate configuration information pre-configured for and pre-stored in a terminal, or may also indicate a case where a terminal is configured by a base station in a cell-common manner. Here, “cell-common” may imply that terminals in a cell receive configuration of the same information from a base station. A method in which a terminal receives a sidelink system information block (SL-SIB) from a base station so as to obtain cell-common information may be considered. In addition, (pre-)configuration may also indicate a case where a terminal is configured by a UE-specific method after an RRC connection is established with a base station. Here, “UE-specific” may also be replaced with the term “UE-dedicated, and may indicate each terminal receiving configuration information having a particular value. A method in which a terminal receives an RRC message from a base station so as to obtain UE-specific information may be considered. In addition, a method in which (pre-)configuration is performed by resource pool information and a method in which (pre-)configuration is not performed by resource pool information may be considered. In a case where (pre-)configuration is performed by resource pool information, excluding a case where a terminal is configured by a UE-specific method after an RRC connection is established with a base station, terminals operating in a corresponding resource pool may all be operated by common configuration information. However, a method in which (pre-)configuration is not performed by resource pool information is basically a method in which (pre-)configuration is performed independently to resource pool information. For example, one or more modes may be (pre-)configured in a resource pool (e.g., A, B, and C), and which mode to be used (e.g., A, B, or C) among the modes (pre-)configured in the resource pool may be indicated through information (pre-)configured independently to resource pool configuration information.

Referring to case 303 in FIG. 3, a case where a resource pool has been continuously allocated in frequency is illustrated. A resource allocation in a frequency axis may be configured by sidelink bandwidth part (BWP) information, and may be performed in a unit of sub-channels. A sub-channel may be defined as a resource allocation unit in frequency, which is configured by one or more physical resource blocks (PRBs). That is, a sub-channel may be defined by an integer multiple of a PRB. Referring to case 303, a sub-channel may be configured by five consecutive PRBs, and a sub-channel size (sizeSubchannel) may be the size of five consecutive PRBs. The description given with reference to the drawing merely corresponds an example of the disclosure. Furthermore, a sub-channel size may be differently configured, and one sub-channel is normally configured by consecutive PRBs, but is not necessarily required to be configured by consecutive PRBs. A sub-channel may be a basic unit of resource allocation for a PSSCH. In case 303, startRB-Subchannel may indicate the starting location of a sub-channel in frequency in a resource pool. When a resource allocation is performed in a unit of sub-channels on a frequency axis, a resource in frequency may be allocated through configuration information such as the index (startRB-Subchannel) of a resource block (RB) on which a sub-channel starts, information (sizeSubchannel) on how many PRBs a sub-channel is configured by, and a total number of sub-channels. Information on startRB-Subchannel, sizeSubchannel, and numSubchannel may be (pre-)configured by information on a resource pool in frequency.

A method for allocating, by a base station, a sidelink transmission resource when a terminal is within the coverage of the base station is one of the methods for allocating a transmission resource in a sidelink. Hereinafter, this method will be called Mode 1. In other words, Mode 1 may show a method by which a base station allocates a resource used in sidelink transmission to RRC-connected terminals in a dedicated scheduling scheme. Through the method of Mode 1, a base station may manage a resource in a sidelink, and thus the method may be effective for interference management and resource pool management. On the other hand, there is a method for allocating a transmission resource through direct sensing in a sidelink by a terminal among methods for allocating a transmission resource in a sidelink. Hereinafter, this method will be called Mode 2. Mode 2 may also be called UE autonomous resource selection. Unlike Mode 1 in which a base station directly involves resource allocation, in Mode 2, a transmission terminal autonomously selects a resource through sensing and a resource selection procedure defined based on a (pre-)configured resource pool, and transmits data through the selected resource. Next, when a transmission resource is allocated through Mode 1 or Mode 2, a terminal may transmit/receive data and control information through a sidelink. The control information may include SCI format 1-A as 1st stage sidelink control information (SCI) transmitted through a physical sidelink control channel (PSCCH). In addition, the control information may include at least one of SCI format 2-A or SCI format 2-B as 2nd stage SCI transmitted through a physical sidelink shared channel (PSSCH).

Next, a method using a positioning signal (positioning reference signal, PRS) transmitted through a downlink and an uplink between a terminal and a base station will be described as positioning for measuring the location of a terminal. In the disclosure, a method using a positioning signal transmitted through a downlink and an uplink between a terminal and a base station is called a radio access technology (RAT) dependent positioning. In addition, other positioning methods may be classified as RAT-dependent positioning. Specifically, in a case of an LTE system, a method such as observed time difference of arrival (OTDOA), uplink time difference of arrival (UTDOA), and enhanced cell identification (E-CID) may be used as an RAT-dependent positioning technique. In a case of an NR system, a method such as downlink time difference of arrival (DL-TDOA), downlink angle-of-departure (DL-AOD), multi-round trip time (multi-RTT), NRE-CID, uplink time difference of arrival (UL-TDOA), and uplink angle-of-arrival (UL-AOA) may be used. Unlike the above description, an RAT-independent positioning technique may include a method such as assisted global navigation satellite systems (A-GNSS), sensor, wireless local area network (WLAN), and Bluetooth.

The disclosure has a particular focus on an RAT-dependent positioning method supported through a sidelink. As described above, RAT-dependent positioning is possible only when a terminal is in the coverage of a base station. In addition, in a case of RAT-dependent positioning, a positioning protocol, such as an LTE positioning protocol (LPP), an LTE positioning protocol annex (LPPa), and an NR positioning protocol annex (NRPPa), may be used. First, an LPP may be considered as a positioning protocol defined between a terminal and a location server (LS), and an LPPa and an NRPPa may be considered as a protocol defined between a base station and a location server. The location server is an entity which manages location measurement, and may perform a function of a location management function (LMF). In addition, the location server may also be called an LMF or another name. In both LTE and NR systems, an LPP is supported, a role as follows for positioning may be performed through the LPP. When a terminal and a location server perform the following role, a base station may perform a role allowing the terminal and the location server to exchange positioning information. The exchange of positioning information through an LPP may be base station-transparently performed. This may imply that a base station does not involve exchange of positioning information between a terminal and a location server. An LPP may include elements as follows.
Positioning capability exchange
Assistance data transmission
Location information transmission
Error processing
Abort

In a case of the positioning capability exchange, positioning information that a terminal is able to support may be exchanged with a location server. For example, whether a positioning method supported by a terminal is UE-assisted, UE-based, or both of them are possible may be indicated. Here, “UE-assisted” indicates a scheme in which a terminal does not directly measure the absolute location of a terminal, and transfers only a measurement value for a positioning technique to the location server, based on an applied and received positioning signal, and the location server calculates the absolute location of the terminal. The absolute location may indicate two-dimensional (x,y) and three-dimensional (x,y,z) coordinate location information on the terminal according to longitude and latitude. On the contrary, “UE-based” may be a scheme in which a terminal directly measures the absolute position of the terminal, and to this end, the terminal is required to receive both a positioning signal and location information on an entity having transmitted the positioning signal.

While, in an LTE system, only a UE-assisted scheme is supported, in an NR system, both UE-assisted positioning and UE-based positioning may be supported. Next, assistance data transmission may be a factor in positioning for measurement of an accurate location of a terminal. Specifically, in a case of assistance data transmission, a location server may provide, to a terminal, configuration information on a positioning signal, and information on a candidate cell and transmission reception point (TRP) to receive a positioning signal. Specifically, when DL-TDOA is used, information on a candidate cell and TRP to receive a positioning signal may be information on a reference cell, a reference TRP, a neighbor cell and a neighbor TRP. In addition, multiple candidate neighbor cells and neighbor TRPs may be provided, and information relating to which cell and TRP is good to be selected by a terminal to measure a positioning signal may be provided together. In order to measure an accurate location, a terminal should select information on a candidate cell and TRP serving as a criterion well. For example, when a channel for a positioning signal received from a corresponding candidate cell and TRP is a line-of-site (LOS) channel, that is when the channel has a small non-LOS (NLOS) channel component, the accuracy of the positioning measurement may be increased. Therefore, when a location server provides, to a terminal, information on a candidate cell and TRP serving as a criterion for positioning through collection of various information, the terminal may perform a more accurate positioning measurement.

Next, location information transmission may be performed through an LPP. A location server may request location information from a terminal, and the terminal may provide measured location information to the location server in response to the corresponding request. In a case of “UE-assisted” corresponding location information may be a measurement value for a positioning technique, obtained based on a received positioning signal. On the other hand, in a case of “UE-based”, corresponding location information may be two-dimensional (x,y) and three-dimensional (x,y,z) coordinate location values of a terminal. When a location server requests location information from a terminal, a required accuracy and response time may be included as positioning quality-of-service (QoS) information. When corresponding positioning QoS information is requested, a terminal provides, to a location server, location information measured to satisfy a corresponding accuracy and response time, and if it is impossible to satisfy QoS, the terminal may consider error processing and abort. However, the above description merely corresponds to an example, and even in other cases rather than the case where it is impossible to satisfy QoS, error processing and abort of positioning may be performed.

Next, in a case of a positioning protocol defined between a base station and a location server, the protocol is named an LPPa in an LTE system, and the following functions may be performed between a base station and a location server.
E-CID location information transmission
OTDOA information transmission
Normal error state reporting
Assistance information transmission

Next, in a case of a positioning protocol defined between a base station and a location server, the protocol is named an NRPPa in an NR system, and the following functions may be performed between a base station and a location server in addition to the above role performed by an LPPa.
Positioning information transmission
Measurement information transmission
TRP information transmission

In the NR system unlike an LTE system, a base station is able to perform positioning measurement through a positioning sound reference signal (SRS) transmitted by a terminal. Therefore, the positioning information transmission indicates a function of exchanging, between a base station and a location server, information related to positioning SRS configuration and activation/deactivation. Next, measurement information transmission indicates a function of exchanging, between a base station and a location server, information related to multi-RTT, UL-TDOA, and UL-AOA which are not supported in an LTE system. Lastly, TRP information transmission indicates a role of exchanging information related to performing of positioning based on a TRP because cell-based positioning is performed in an LTE system, but TRP-based positioning is able to be performed in an NR system.

An entity performing configuration related to positioning so as to measure the location of a terminal in a sidelink and an entity calculating positioning may be given in three types as below.
UE (no LS)
LS (through BS)
LS (through UE)

The LS indicates a location server, the BS indicates a base station such as a gNB or an eNB, and the UE indicates a terminal performing transmission or reception through a sidelink. As described above, a terminal performing transmission or reception through a sidelink may be a vehicle terminal and a pedestrian terminal. In addition, a terminal performing transmission or reception through a sidelink may include a roadside unit (RSU) equipped with a terminal function, an RSU equipped with a base station function, or an RSU equipped with a part of a base station function and a part of a terminal function. Moreover, a terminal performing transmission or reception through a sidelink may include a positioning reference unit (PRU) for which the location of a terminal is known. The UE (no LS) indicates a sidelink terminal which is not connected to a location server. The LS (through the BS) is a location server, and indicates a location server connected to a base station. On the contrary, the LS (through the UE) is a location server, and indicates a location server connected to a sidelink terminal. The LS (through the UE) may be available only for a particular terminal, such as an RSU or PRU, rather than a normal terminal. A terminal connected to a location server in a sidelink may be defined as a new type of terminal (device). Only a particular terminal supporting the UE capability of being connected to a location server may perform a function of being connected to a location server through a sidelink.

Case 1 to case 9 in Table 1 show various combinations according to an entity performing configuration related to positioning so as to measure the location of a terminal in a sidelink and an entity calculating (determining) positioning. In the disclosure, a terminal, the location of which is required to be measured, is named a target terminal. In addition, a terminal, the location of which is known, and which is capable of providing corresponding information for measurement of the location of the target terminal, is named an anchor terminal. The location of an anchor terminal may be already known (an anchor terminal may be positioned at a known location). It is noted that the names of a target terminal and an anchor terminal may be replaced with other terms. For example, an anchor terminal may be named a positioning reference unit (PRU). In addition, positioning configuration may be classified as a UE-configured scheme and a network-configured scheme. In Table 1, when positioning configuration is a UE (no LS), a UE-configured scheme may be applied. The UE-configured scheme is advantageous in that positioning configuration is possible even when a terminal is not within the coverage of a network (base station). In Table 1, when positioning configuration is an LS (through the BS), a network-configured scheme may be applied. In the network-configured scheme, when a terminal is in the coverage of a network, the terminal reports positioning calculation and measurement information to a base station, and a location server connected to the base station performs a location measurement of a target UE. Therefore, a delay may occur due to signaling related to the location measurement, but it may be possible to measure an accurate location. Lastly, in Table 1, a case where positioning configuration is an LS (through the UE) is not a scheme in which a terminal operates via a base station within the coverage of a network, and thus may not be classified as a network-configured scheme. In addition, the case may not be classified as a UE-configured scheme because a location is measured by a location server connected to a terminal, but the terminal does not perform measurement in the strict sense. Therefore, a case of an LS (through the UE) may also be named a different scheme other than a UE-configured or network-configured scheme.

In addition, as described above, positioning calculation (determination) may be classified as two schemes including a UE-assisted scheme and a UE-based scheme. In Table 1, a case where positioning calculation is a UE (no LS) may correspond to a UE-based scheme, and a case where positioning calculation is an LS (through the BS) or an LS (through the UE) may generally correspond to a UE-assisted scheme. However, a case where positioning calculation is an LS (through UE), and the UE is a target UE may be classified as a UE-based scheme.

TABLE 1

| | Positioning configuration | Positioning calculation |
|---|---|---|
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through UE) | UE (no LS) |
| Case 8 | LS (through UE) | LS (through BS) |
| Case 9 | LS (through UE) | LS (through UE) |

In Table 1, positioning configuration information may include sidelink positioning reference signal (S-PRS) configuration information. The S-PRS configuration information may be related to pattern information and a time/frequency transmission location of an S-PRS. In addition, in Table 1, in positioning calculation, a terminal may receive an S-PRS, and perform a measurement by using the received S-PRS, and a positioning measurement and calculation method may vary according to which positioning method is applied. A measurement of location information in a sidelink may be absolute positioning by which two-dimensional (x,y) and three-dimensional (x,y,z) coordinate location values of a terminal are provided, or may be relative positioning by which relative two-dimensional and three-dimensional location information for a different terminal are provided. In addition, location information in a sidelink may be merely ranging information including one of a distance or a direction from a different terminal. If ranging information that is location information in a sidelink includes both distance information and direction information, ranging may have the same meaning as relative positioning. In addition, a method, such as sidelink time difference of arrival (SL-TDOA), sidelink angle-of-departure (SL-AOD), sidelink multi-round trip time (SL Multi-RTT), sidelink E-CID, and sidelink angle-of-arrival (SL-AOA), may be considered as a positioning method.

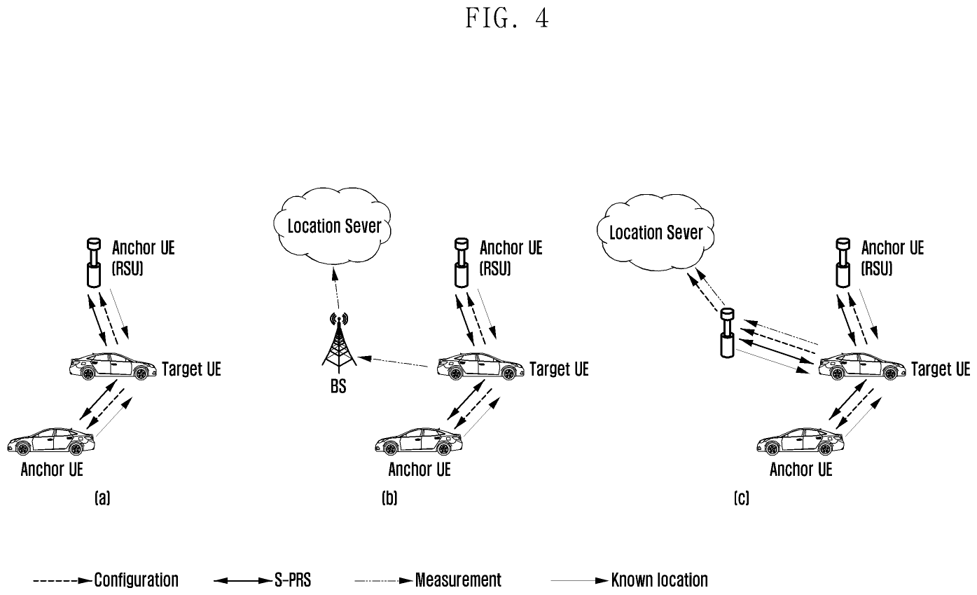

FIG. 4 to FIG. 6 illustrate cases of calculating the location of a terminal through a sidelink according to an embodiment. However, in the disclosure, a case of calculating the location of a terminal through a sidelink is not limited to the cases illustrated in FIG. 4 to FIG. 6.

Part (a) of FIG. 4 shows an example of a case where a sidelink terminal having no connection with a location server provides the positioning configuration, and a target terminal having no connection with the location server performs the positioning calculation (determination). This case may correspond to case 1 in Table 1. In this case, the target terminal may broadcast, unicast, or groupcast an indication of positioning-related configuration information to a different terminal through a sidelink. In addition, the target terminal may perform the positioning calculation, based on a received positioning signal.

Part (b) of FIG. 4 shows an example of a case where a sidelink terminal having no connection with a location server provides the positioning configuration, and a target terminal is positioned within the coverage of a network and thus the location server connected to a base station performs the positioning calculation. This case may correspond to case 2 in Table 1. In this case, the target terminal may broadcast, unicast, or groupcast an indication of positioning-related configuration information to a different terminal through a sidelink. In addition, the target terminal may perform the positioning measurement, based on a received positioning signal, and report, to the base station, measured positioning information due to the target terminal being within the coverage of the base station. The corresponding measurement information is reported to the location server connected to the base station, and thus the location server may perform the positioning calculation.

Part (c) of FIG. 4 shows an example of a case where a sidelink terminal having no connection with a location server provides the positioning configuration, and the location server performs the positioning calculation via a sidelink terminal connected to the location server. This case may correspond to case 3 in Table 1. In this case, a target terminal may broadcast, unicast, or groupcast an indication of positioning-related configuration information to a different terminal through a sidelink. In addition, the target terminal may perform the positioning measurement, based on a received positioning signal, and report, to the terminal connected to the location server, measured positioning information due to the target terminal being within a sidelink coverage with the terminal connected to the location server. Part (c) of FIG. 4 shows that the terminal connected to the location server is an anchor UE (RSU), but it is noted that the terminal may be a terminal other than an RSU. Thereafter, the corresponding measurement information is reported to the location server connected to the anchor UE (RSU), and thus the location server may perform the positioning calculation.

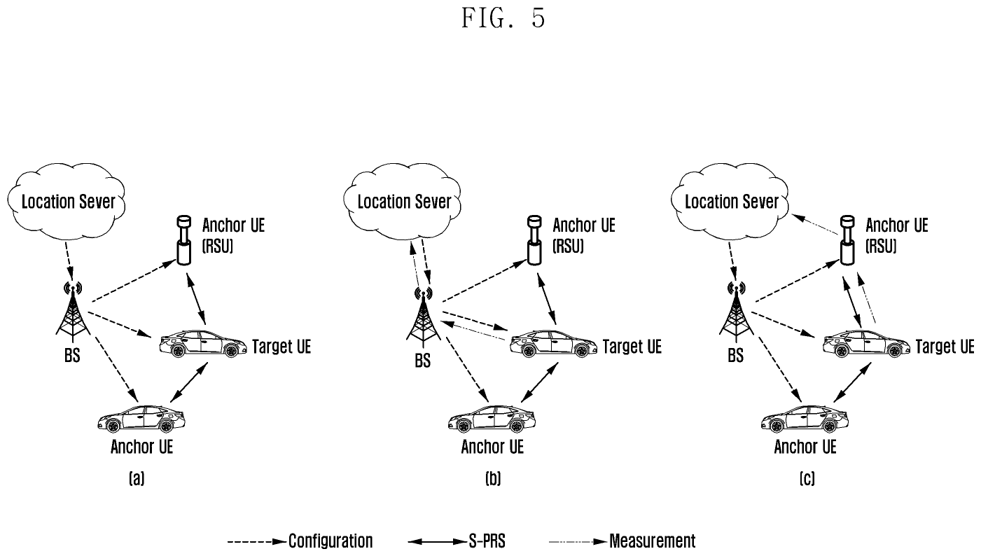

Part (a) of FIG. 5 shows an example of a case where a sidelink terminal is positioned in the coverage of a network, and thus a location server connected to a base station provides a positioning configuration, and a target terminal having no connection with the location server performs the positioning calculation. This case may correspond to case 4 in Table 1. In this case, the location server connected to the base station may provide the positioning configuration information by using a positioning protocol such as an LPP. In addition, the target terminal may perform the positioning calculation, based on received configuration information and a received positioning signal.

Part (b) of FIG. 5 shows an example of a case where a sidelink terminal is positioned in the coverage of a network, and thus a location server connected to a base station provides the positioning configuration, and a target terminal is positioned within the coverage of the network and thus the location server connected to the base station performs the positioning calculation. This case may correspond to case 5 in Table 1. In this case, the location server connected to the base station may provide the positioning configuration information by using a positioning protocol such as an LPP. In addition, the target terminal may perform the positioning measurement, based on received configuration information and a received positioning signal, and report, to the base station, measured positioning information due to the target terminal being within the coverage of the base station. The corresponding measurement information is reported to the location server connected to the base station, and thus the location server may perform the positioning calculation.

Part (c) of FIG. 5 shows an example of a case where a sidelink terminal is positioned in the coverage of a network, and thus a location server connected to a base station provides the positioning configuration, and the location server performs the positioning calculation via the sidelink terminal connected to the location server. This case may correspond to case 6 in Table 1. In this case, the location server connected to the base station may provide the positioning configuration information by using a positioning protocol such as an LPP. In addition, a target terminal may perform the positioning measurement, based on received configuration information and a received positioning signal, and report, to the terminal connected to the location server, measured positioning information due to the target terminal being within a sidelink coverage with the terminal connected to the location server. Part (c) of FIG. 5 shows that the terminal connected to the location server is an anchor UE (RSU), but it is noted that the terminal may be a terminal other than an RSU. Thereafter, the corresponding measurement information is reported to the location server connected to the anchor UE (RSU), and thus the location server may perform the positioning calculation.

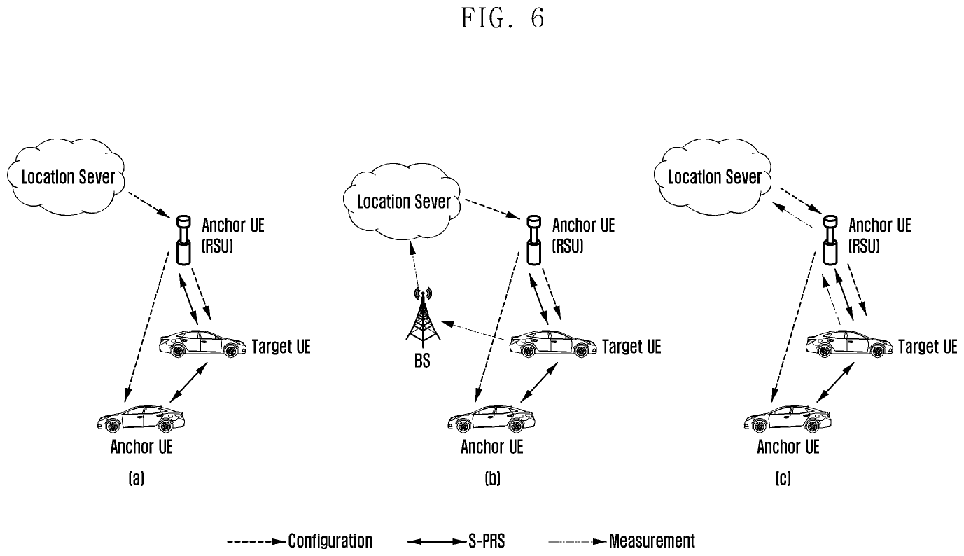

Part (a) of FIG. 6 shows an example of a case where a location server provides the positioning configuration via a sidelink terminal connected to the location server, and a target terminal having no connection with the location server performs the positioning calculation. This case may correspond to case 7 in Table 1. In this case, a positioning protocol such as an LPP may be used so that the location server connected to the terminal provides the positioning configuration information. In addition, the target terminal may perform the positioning calculation, based on received configuration information and a received positioning signal.

Part (b) of FIG. 6 shows an example of a case where a location server provides the positioning configuration via a sidelink terminal connected to the location server, and a target terminal is positioned within the coverage of a network and thus the location server connected to a base station performs the positioning calculation. This case may correspond to case 8 in Table 1. In this case, a positioning protocol such as an LPP may be used so that the location server connected to the terminal provides the positioning configuration information. In addition, the target terminal may perform the positioning measurement, based on received configuration information and a received positioning signal, and report, to the base station, measured positioning information due to the target terminal being within the coverage of the base station. The corresponding measurement information is reported to the location server connected to the base station, and thus the location server may perform the positioning calculation.

Part (c) of FIG. 6 shows an example of a case where a location server provides the positioning configuration via a sidelink terminal connected to the location server, and the location server performs the positioning calculation via the sidelink terminal connected to the location server. This case may correspond to case 9 in Table 1. In this case, a positioning protocol such as an LPP may be used so that the location server connected to the terminal provides positioning the configuration information. In addition, a target terminal may perform the positioning measurement, based on received configuration information and a received positioning signal, and report, to the terminal connected to the location server, measured positioning information due to the target terminal being within a sidelink coverage with the terminal connected to the location server. Part (c) of FIG. 6 shows that the terminal connected to the location server is an anchor UE (RSU), but it is noted that the terminal may be a terminal other than an RSU. Thereafter, the corresponding measurement information is reported to the location server connected to the anchor UE (RSU), and thus the location server may perform the positioning calculation.

The following embodiments propose methods for supporting RAT-dependent positioning supported through a sidelink. Specifically, the following embodiments propose methods for selecting, by a terminal, a terminal serving as a criterion of location measurement when positioning is performed through a sidelink. In the above description, a terminal, the location of which is to be measured, has been named a target terminal. The target terminal selecting a terminal serving as a criterion of location measurement may affect the accuracy of location measurement very much. In other words, when a positioning signal received from a selected terminal is not suitable for location measurement, a location measured therethrough may not be correct. Therefore, a terminal selecting a reference terminal suitable for location measurement in a sidelink is a very important factor for positioning. In the disclosure, such a reference terminal used for location measurement is named a measurement source. In the disclosure, a measurement source may be an anchor terminal, the location of which is already known (is a known location), or a terminal, the location of which is unknown (is an unknown location). When a measurement source is an anchor terminal, corresponding location information is transferred to a target terminal so that the target terminal may perform UE-based positioning.

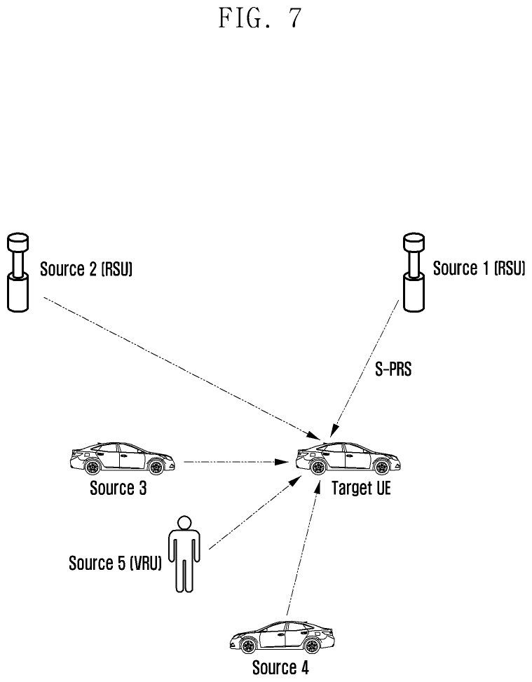

FIG. 7 illustrates a measurement source that is a reference terminal used for location measurement in a case of performing positioning through a sidelink by a target terminal according to an embodiment. According to FIG. 7, five measurement sources usable by a target terminal are illustrated. A case where measurement source 1 and measurement source 2 are roadside units (RSUs), a case where measurement source 3 and measurement source 4 are vehicles, and a case where measurement source 5 is a vulnerable road user (VRU) are illustrated. The VRU may be a person who is moving with a cell phone as illustrated. Generally, when the movement of a terminal is considered, the priorities of the measurement sources may be determined according to the order of RSU>VRU>Vehicle. For example, a vehicle moving at a high speed may be unsuitable as a reference terminal used for location measurement.

A case where a terminal is required to select a measurement source suitable for location measurement may be a case where the number of available measurement sources is greater than the number of measurement sources needed by a target terminal. Therefore, in the disclosure, the number of measurement sources usable by a target terminal is defined by M(≥1). In addition, the number of measurement sources needed for a target terminal to perform location measurement is defined by N(≥1). It is noted that N, which is the number of needed measurement sources, may vary according to which positioning method a target terminal uses. In addition, in the disclosure, it is noted that one or more among the following embodiments may be combined together to be used.

### First Embodiment

The first embodiment proposes a method using reliability information as a method for selecting, by a terminal, a terminal serving as a criterion of location measurement when positioning is performed through a sidelink is needed. The reliability information may be a measure of how reliable use of, for positioning measurement, a terminal serving as a criterion of location measurement is. As described with reference to FIG. 7, when there are multiple measurement sources usable by a target terminal, the measurement sources may have different reliabilities. In FIG. 7, reliability may be determined to increase in the order of RSU>VRU>vehicle, based on a movement speed of a terminal. If the target terminal receives reliability information on a measurement source from the corresponding measurement source, the target terminal may select a measurement source or determine a positioning method, based on the information.

When a terminal corresponding to a measurement source provides reliability information to the target terminal, reliability may be determined by a method(s) as below. In the disclosure, it is noted that a method for determining reliability when a terminal corresponding to a measurement source provides reliability information to the target terminal is not limited to the following methods. In addition, reliability may also be determined by a combination of the following methods.
Method 1: Determination by the speed of a terminal serving as a measurement source
Method 2: Determination by sidelink reception power between a terminal serving as a measurement source and a target terminal
Method 3: Determination through non line-of-sight (NLOS) identification of a sidelink channel between a terminal serving as a measurement source and a target terminal

In a case of method 1, when the speed of a terminal serving as a measurement source is high, reliability may be determined to be low. The higher speed a terminal has, the higher the uncertainty of the state of a link between terminals may be. This is because, for example, when the speed is high, a change in the already known location (known location) of an anchor terminal may be increased. Therefore, when an anchor terminal has transferred location (known location) information to the target terminal, the information may not be valid information any longer. Specifically, in a case where a threshold value for speed is defined and the speed of a terminal exceeds the threshold value, reliability may be determined to be low. When multiple threshold values for speed are defined, reliability may be determined to be in multiple levels. For example, when X threshold values are defined, X+1 reliability levels may be partitioned as below. The corresponding threshold value(s) may be (pre-)configured by sidelink information.

In a case of method 2, in a case where a terminal serving as a measurement source is able to measure sidelink reception power between the terminal and a target terminal, when the reception power is low, reliability may be determined to be low. This is because the larger the reception power, the higher the possibility that a channel between the two terminals may be determined to be good. In addition, measurement of reception power may indicate measurement of reference signal received power (RSRP). In addition, it is noted that RSRP may be measured through various methods. For example, RSRP may indicate PSBCH-RSRP, PSSCH-RSRP, or PSCCH-RSRP. The above RSRPs may indicate RSRPs measured through reference signals transmitted through a physical sidelink broadcast channel (PSBCH), a physical sidelink shared channel (PSSCH), and a physical sidelink control channel (PSCCH), respectively. In addition, RSRP may be measured through a sidelink positioning reference signal (S-PRS). In addition, RSRP may be layer-3 filtered RSRP. Layer-1 filtered RSRP may be an instantaneous value, and thus layer-3 filtered RSRP may indicate an RSRP value closer to the average, which is obtained through filtering. In a case where a threshold value for reception power is defined and a measured reception power exceeds the threshold value, reliability may be determined to be high. When multiple threshold values for reception power are defined, reliability may be determined to be in multiple levels. For example, when X threshold values are defined, X+1 reliability levels may be partitioned as below. The corresponding threshold value(s) may be (pre-)configured by sidelink information.

In a case of method 3, in a case where a terminal serving as a measurement source is able to perform an NLOS identification of a sidelink channel between the terminal and a target terminal, the higher the NLOS channel component is, the lower the reliability may be determined. This is because, as the NLOS channel component of a channel between the terminals becomes lower, the accuracy in positioning measurement may be improved. In other words, when there is only one line-of-sight (LOS) component, the accuracy in positioning measurement may become the highest. In addition, as a multi-path component of a channel increases and an NLOS component grows larger, the accuracy in positioning measurement may become lower. In order to use method 3, when a terminal serving as a measurement source receives a signal from a target terminal, and then performs a channel estimation, the terminal may determine how much a corresponding channel has an NLOS channel component, through an algorithm for NLOS identification. The algorithm for NLOS identification requires additional terminal processing, and thus only a terminal capable of performing a corresponding function according to terminal capability may be able to support the algorithm. Specifically, in a case where a threshold value for the NLOS channel component is defined and a measured NLOS channel component exceeds the threshold value, reliability may be determined to be low. When multiple threshold values for the NLOS channel component are defined, reliability may be determined to be in multiple levels. For example, when X threshold values are defined, X+1 reliability levels may be partitioned as below. The corresponding threshold value(s) may be (pre-)configured by sidelink information.

A terminal serving as a measurement source may broadcast, unicast, or groupcast an indication of reliability information determined by the proposed methods to a target terminal through a sidelink. The corresponding information may be indicated through SCI (1st stage SCI or 2nd stage SCI), or indicated through PC5-RRC or a sidelink MAC-CE in a case of unicast transmission. For example, alternatives as follows may be considered when reliability information is indicated.
Alternative 1: Low and high reliability is indicated by 1-bit information. For example, “0” may indicate low reliability, and “1” may indicate high reliability.
Alternative 2: A probability value corresponding to 0≤reliability≤1 may be indicated by reliability information. When X reliability levels are indicated, ceil(log 2(X)) bits may be needed. Here, ceil( ) indicates a roundup function, and log 2( ) is a log function having a base of 2.

In the disclosure, it is noted that an alternative by which a terminal corresponding to a measurement source indicates reliability information to a target terminal is not limited to the above alternatives. For example, a terminal serving as a measurement source may also directly indicate, to a target terminal, the speed of the terminal, a value corresponding to reception power, or a value corresponding to NLOS identification.

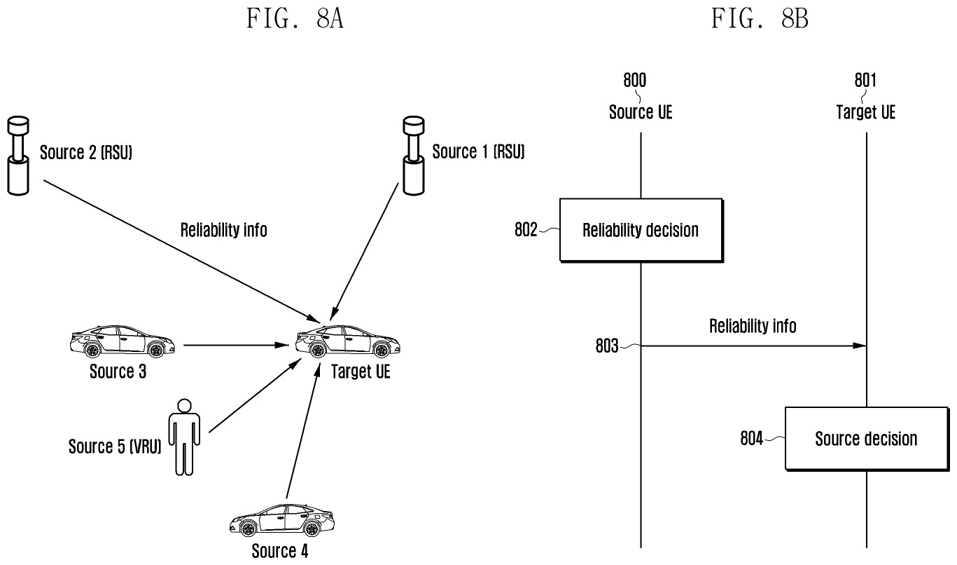

FIG. 8A illustrates a method for indicating reliability information to a target terminal through a sidelink by a terminal serving as a measurement source according to an embodiment, and FIG. 8B illustrates a method for indicating reliability information to a target terminal through a sidelink by a terminal serving as a measurement source according to an embodiment. According to FIG. 8A, five measurement sources usable by a target terminal are illustrated. Terminals serving as measurement sources are illustrated to indicate reliability information to the target terminal. According to FIG. 8B, a terminal 800 serving as a measurement source may, in operation 802, determine how much reliability the terminal has as a measurement source for positioning. Methods 1 to 3 proposed above may be considered. Next, in operation 803, the terminal 800 may indicate reliability information to a target terminal 801. In a method for indicating the corresponding information the information may be indicated through SCI (1st stage SCI or 2nd stage SCI), or indicated through PC5-RRC or a sidelink MAC-CE in a case of unicast transmission, as described above. Next, in operation 804, the target terminal 801 may determine, based on the reliability information, whether to use the terminal 800 as a measurement source for positioning. Specifically, in a case where alternative 1 mentioned above is used, when “0” is indicated, the target terminal may determine low reliability, and may not use the terminal 800 as a measurement source for positioning. On the contrary, when “1” is indicated, the target terminal may determine high reliability, and may use the terminal 800 as a measurement source for positioning. When alternative 2 is used, the target terminal may determine, based on a threshold point for one or more reliabilities, whether to use the terminal 800 as a measurement source for positioning. The threshold point for reliability may be (pre-)configured by sidelink information. If there is no measurement source usable by the target terminal 801 for positioning in operation 804, the terminal may declare error processing and abort of positioning, and the error processing and abort may be processed according to a positioning protocol such as the above LPP. In addition, a positioning method to be used may vary according to the number of measurement sources usable by the target terminal 801 for positioning in operation 804. For example, in a case where the target terminal is to obtain an absolute position of the terminal, the number of measurement sources may be needed to be equal to or greater than Y. However, when the number of available measurement sources in operation 804 is smaller than Y, the target terminal may not perform positioning for an absolute location and may perform relative positioning or ranging, based on one measurement source. When Y is greater than 1 (Y>1), the target terminal may select the best measurement source determined in operation 804, and perform relative positioning or ranging, based on the selected measurement source.

### Second Embodiment

The second embodiment proposes a method in which a target terminal uses a reception power measurement by a measurement source, as a method for selecting, by a terminal, a terminal serving as a criterion of location measurement when positioning is performed through a sidelink is needed. The measurement of reception power may indicate measurement of reference signal received power (RSRP). In addition, it is noted that the RSRP may be measured through various methods. For example, the RSRP may indicate PSBCH-RSRP, PSSCH-RSRP, or PSCCH-RSRP. The above RSRPs may indicate RSRPs measured through reference signals transmitted through a physical sidelink broadcast channel (PSBCH), a physical sidelink shared channel (PSSCH), and a physical sidelink control channel (PSCCH), respectively. In addition, the RSRP may be measured through a sidelink positioning reference signal (S-PRS). In addition, the RSRP may be layer-3 filtered RSRP. Layer-1 filtered RSRP may be an instantaneous value, and thus layer-3 filtered RSRP may indicate an RSRP value closer to the average, which is obtained through filtering.

When a target terminal performs a reception power measurement by a measurement source so as to select a measurement source, the target terminal may select a measurement source having a high measured reception power. This is because the larger the reception power, the higher the possibility that a channel between the two terminals may be determined to be good. When M is greater than N (M>N), the terminal may select N measurement sources having good reception power. If there are Z (>1) measurement sources having the same reception power among the selected N measurement sources, the terminal may randomly select one of the Z measurement sources, determine same by terminal implementation, or determine same, based on different information. For example, the different information may include distance information, sync priority information, and sync hop information. For example, when reception power is used, a measurement source having a high RSRP value may be selected from among the Z measurement sources. In addition, a threshold value for reception power is defined and a measured reception power exceeds the threshold value, a measurement source(s) may be selected as a candidate for positioning. Multiple threshold values for reception power may be defined according to different requirements for positioning or a method and environment in which positioning is performed. A method in which these threshold value(s) are (pre-)configured by sidelink information may be used. Alternatively, a method for implicitly determining multiple threshold values may also be considered. For example, in a case where multiple S-PRS patterns are supported or in a case where an S-PRS pattern requiring a high positioning accuracy is configured (this case may correspond to a case of having a high time and frequency S-PRS pattern), a high threshold value may be configured. On the other hand, in a case where an S-PRS pattern requiring a low positioning accuracy is configured (this case may correspond to a case of having a low time and frequency S-PRS pattern), a low threshold value may be configured.

If a UE-assisted positioning technique is used, information on a corresponding reception power together with a measurement value for the positioning technique may be needed to be transferred to a location server. As described above, “UE-assisted” indicates a scheme in which a terminal does not directly measure the absolute location of a terminal, and transfers only a measurement value for a positioning technique to the location server, based on an applied and received positioning signal, and the location server calculates the absolute location of the terminal. Therefore, when a measurement value and information on a corresponding reception power are indicated to a terminal connected to a location server through a sidelink, a target terminal may broadcast, unicast, or groupcast same to a different terminal. The corresponding information may be indicated through SCI (1st stage SCI or 2nd stage SCI), or indicated through PC5-RRC or a sidelink MAC-CE in a case of unicast transmission.

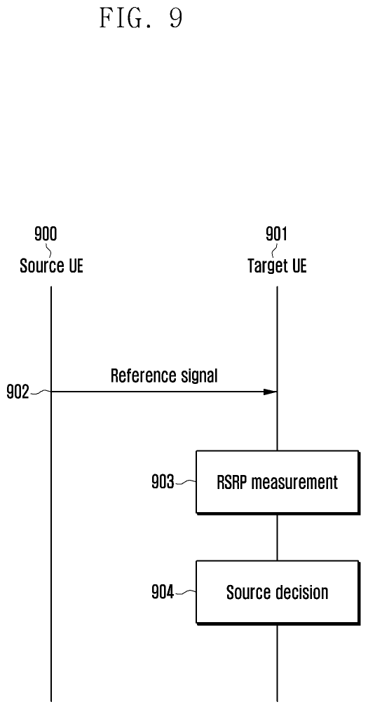

FIG. 9 illustrates a method for selecting a measurement source, based on a reception power measurement by a target terminal according to an embodiment. According to FIG. 9, a terminal 900 serving as a measurement source may transmit a reference signal 902 to a target terminal 901 so as to allow the target terminal 901 to measure reception power, such as RSRP. For the reference signal, methods for using a reference signal transmitted through various channels or a method using S-PRS transmission may be considered as described above. The target terminal 901 may measure a reception power in operation 903, and determine whether a measurement source is suitable for positioning measurement, in operation 904. If there is no measurement source usable by the target terminal 901 for positioning in operation 904, the terminal may declare error processing and abort of positioning, and the error processing and abort may be processed according to a positioning protocol such as the above LPP. In addition, a positioning method to be used may vary according to the number of measurement sources usable by the target terminal 901 for positioning in operation 904. For example, in a case where the target terminal is to obtain an absolute location of the terminal, the number of measurement sources may be needed to be equal to or greater than Y. However, when the number of available measurement sources in operation 904 is smaller than Y, the target terminal may not perform positioning for an absolute location and may perform relative positioning or ranging, based on one measurement source. When Y is greater than 1 (Y>1), the target terminal may select the best measurement source determined in operation 904, and perform relative positioning or ranging, based on the selected measurement source.

### Third Embodiment

The third embodiment proposes a method in which a target terminal uses a non line-of-sight (NLOS) identification of a channel by a measurement source, as a method for selecting, by a terminal, a terminal serving as a criterion of location measurement when positioning is performed through a sidelink is needed.

When a target terminal performs an NLOS identification of a channel by a measurement source so as to select a measurement source, the target terminal may select a measurement source having a low NLOS channel component. This is because, as the NLOS channel component of a channel between the terminals becomes lower, the accuracy in positioning measurement may be improved. In other words, when there is only one line-of-sight (LOS) component, the accuracy in positioning measurement may become the highest. In addition, as a multi-path component of a channel increases and an NLOS component grows larger, the accuracy in positioning measurement may become lower. In order to perform NLOS identification, when a target terminal receives a signal from a terminal serving as a measurement source, and then performs a channel estimation, the target terminal may determine how much a corresponding channel has an NLOS channel component, through an algorithm for NLOS identification. The algorithm for NLOS identification requires additional terminal processing, and thus only a terminal capable of performing a corresponding function according to terminal capability may be able to support the algorithm. When M is greater than N (M>N), the terminal may select N measurement sources having a low NLOS channel component. If there are Z (>1) measurement sources having the same reception power among the selected N measurement sources, the terminal may randomly select one of the Z measurement sources, determine same by terminal implementation, or determine same, based on different information. For example, the different information may include reception power information, distance information, sync priority information, and sync hop information. In addition, a threshold value for the NLOS channel component is defined and a measured NLOS channel component does not exceed the threshold value, a measurement source(s) may be selected as a candidate for positioning. Specifically, the NLOS channel component is measured, and may be expressed by alternatives as below.
Alternative 1: Whether a channel is an LOS channel or an NLOS channel is expressed by one-bit information. For example, “0” may indicate an LOS channel, and “1” may indicate an NLOS channel.
Alternative 2: A probability value corresponding to 0≤NLOS channel component≤1 may be expressed by the NLOS channel component. When X levels of the NLOS channel component are indicated, ceil(log 2(X)) bits may be needed. Here, ceil( ) indicates a roundup function, and log 2( ) is a log function having a base of 2.

When alternative 1 is used, a threshold value for the NLOS channel component may be configured to be, for example, 0.5. When alternative 2 is used, a threshold value for the NLOS channel component may be configured to be an integer value between 0 and 1. When alternative 2 is used, multiple threshold values for reception power may be defined according to different requirements for positioning or a method and environment in which positioning is performed. A method in which these threshold value(s) are (pre-)configured by sidelink information may be used. Alternatively, a method for implicitly determining multiple threshold values may also be considered. For example, in a case where multiple S-PRS patterns are supported or in a case where an S-PRS pattern requiring a high positioning accuracy is configured (this case may correspond to a case of having a high time and frequency S-PRS pattern), a high threshold value may be configured. On the other hand, in a case where an S-PRS pattern requiring a low positioning accuracy is configured (this case may correspond to a case of having a low time and frequency S-PRS pattern), a low threshold value may be configured.

If a UE-assisted positioning technique is used, information on a corresponding NLOS channel component together with a measurement value for the positioning technique may be needed to be transferred to a location server. As described above, “UE-assisted” indicates a scheme in which a terminal does not directly measure the absolute location of a terminal, and transfers only a measurement value for a positioning technique to the location server, based on an applied and received positioning signal, and the location server calculates the absolute location of the terminal. Therefore, when a measurement value and information on a corresponding NLOS channel component are indicated to a terminal connected to a location server through a sidelink, a target terminal may broadcast, unicast, or groupcast same to a different terminal. The corresponding information may be indicated through SCI (1st stage SCI or 2nd stage SCI), or indicated through PC5-RRC or a sidelink MAC-CE in a case of unicast transmission. When information on the NLOS channel component is indicated, one-bit or X-bit information may be needed according to alternative 1 and alternative 2.

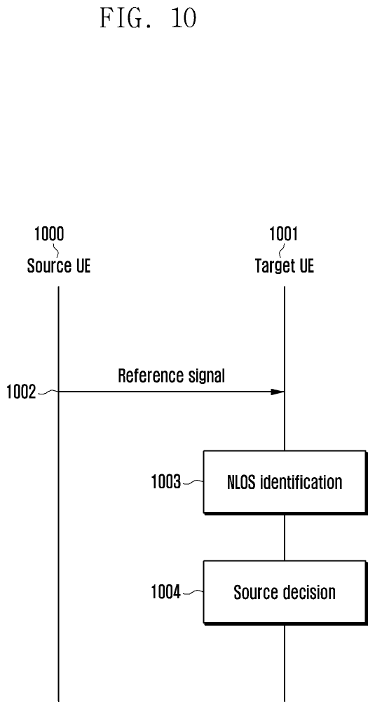

FIG. 10 illustrates a method for selecting a measurement source through an NLOS identification by a target terminal according to an embodiment. According to FIG. 10, a terminal 1000 serving as a measurement source may transmit a reference signal 1002 to a target terminal 1001 so as to allow the target terminal 1001 to perform NLOS identification. For the reference signal, methods for using a reference signal transmitted through various channels or a method using S-PRS transmission may be considered. The target terminal 1001 may perform an NLOS identification in operation 1003, and determine whether a measurement source is suitable for positioning measurement, in operation 1004. If there is no measurement source usable by the target terminal 1001 for positioning in operation 1004, the terminal may declare error processing and abort of positioning, and the error processing and abort may be processed according to a positioning protocol such as the above LPP. In addition, a positioning method to be used may vary according to the number of measurement sources usable by the target terminal 1001 for positioning in operation 1004. For example, in a case where the target terminal is to obtain an absolute location of the terminal, the number of measurement sources may be needed to be equal to or greater than Y. However, when the number of available measurement sources in operation 1004 is smaller than Y, the target terminal may not perform positioning for an absolute location and may perform relative positioning or ranging, based on one measurement source. When Y is greater than 1 (Y>1), the target terminal may select the best measurement source determined in operation 1004, and perform relative positioning or ranging, based on the selected measurement source.

### Fourth Embodiment

The first embodiment has proposed a method for indicating, by a terminal serving as a measurement source, reliability information to a target terminal through a sidelink, as illustrated in FIGS. 8A and 8B. The fourth embodiment provides an overall procedure of sidelink positioning between terminals through the method proposed in the first embodiment, and a result of performance improvement through an experiment.

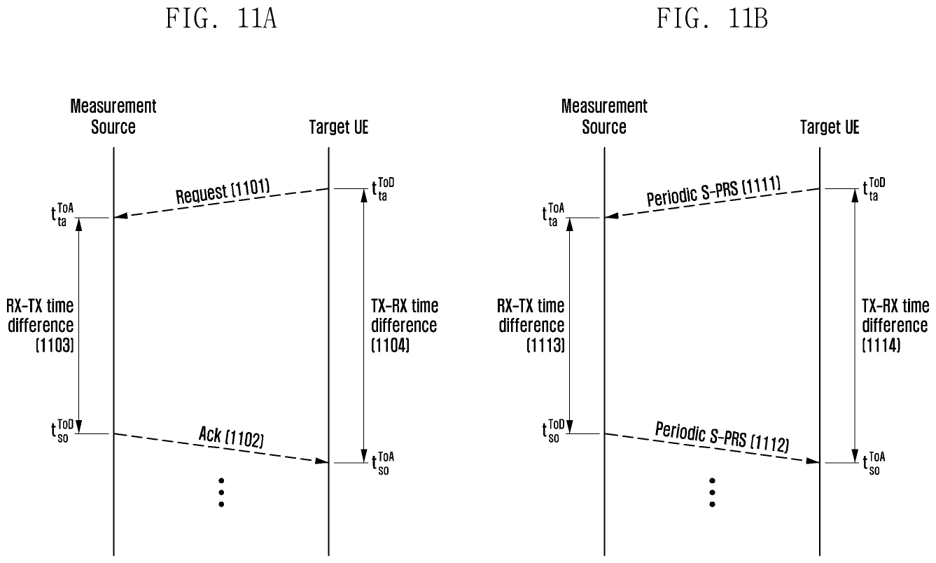

FIG. 11A illustrates a case in which a round trip time (RTT) is applied as a positioning measurement method, and FIG. 11B illustrates a case in which a round trip time (RTT) is applied as a positioning measurement method. However, a positioning measurement method which is applicable to the disclosure is not limited thereto. It is noted that a method proposed in the disclosure may be used in various positioning measurement methods.

Specifically, FIG. 11A shows a case where an RTT is performed by a request 1101 of a target terminal. The target terminal may broadcast, unicast, or groupcast a signal requesting positioning to a neighboring terminal through a sidelink. The corresponding information may be indicated through SCI (1st stage SCI or 2nd stage SCI), transmitted through a PSSCH, or indicated through PC5-RRC or a sidelink MAC-CE. The target terminal transmits a sidelink positioning reference signal (S-PRS) together with the signal 1101 requesting positioning. A terminal able to serve as a measurement source may receive a positioning request from the target terminal, and use an S-PRS to measure a time of arrival (TOA). A corresponding sidelink resource allowing transmission of an S-PRS may be allocated to the target terminal by a base station, or may be directly allocated by the terminal, so that the terminal may transmit the S-PRS to a neighboring terminal. Next, a corresponding sidelink resource allowing transmission of an S-PRS in response to the positioning request 1101 of the target terminal may be allocated to the terminal able to serve as a measurement source, by a base station, or may be directly allocated by the terminal, so that the terminal may transmit the S-PRS to the target terminal. The sidelink resource allowing transmission of an S-PRS may also be simultaneously used in a time and frequency resource area and a resource pool in which a PSSCH is transmitted. On the other hand, the sidelink resource allowing transmission of an S-PRS may be configured to be separate from a time and frequency resource area and a resource pool in which a PSSCH is transmitted, so as not to overlap with same (this may be named a dedicated resource allocation scheme). The transmission of the S-PRS by the terminal able to serve as a measurement source in response to the positioning request 1101 of the target terminal may be interpreted as an acknowledgement (ACK) of operation 1102. The terminal able to serve as a measurement source may provide other pieces of positioning-related information as well as the S-PRS in response to the positioning request 1101 of the target terminal, and these information may also be interpreted as the Ack 1102. In the disclosure, corresponding information is not limited to only particular information. An example of the positioning-related information provided through the Ack 1102 may be location information (a known location) on a measurement source. The location information may be indicated through SCI (1st stage SCI or 2nd stage SCI), transmitted through a PSSCH, or indicated through PC5-RRC or a sidelink MAC-CE. Another example of the positioning-related information provided through the Ack 1102 may be reliability information proposed in the first embodiment. The reliability information may be indicated through SCI (1st stage SCI or 2nd stage SCI), transmitted through a PSSCH, or indicated through PC5-RRC or a sidelink MAC-CE. Another example of the positioning-related information provided through the Ack 1102 may be RX-TX time difference information 1103. The RX-TX time difference information may be indicated through SCI (1st stage SCI or 2nd stage SCI), transmitted through a PSSCH, or indicated through PC5-RRC or a sidelink MAC-CE. When the target terminal receives the S-PRS transmitted by the terminal able to serve as a measurement source in response to the positioning request 1101 of the target terminal, the target terminal may measure a TOA by using the S-PRS.

On the contrary, FIG. 11B shows a case where an RTT is performed by S-PRSs 1111 and 1112 periodically transmitted. A corresponding sidelink resource allowing periodic transmission of an S-PRS may be allocated by a base station, or may be directly allocated by a terminal, so that the S-PRS may be transmitted to a different terminal. The sidelink resource allowing transmission of an S-PRS may also be simultaneously used in a time and frequency resource area and a resource pool in which a PSSCH is transmitted. On the other hand, the sidelink resource allowing transmission of an S-PRS may be configured to be separate from a time and frequency resource area and a resource pool in which a PSSCH is transmitted, so as not to overlap with same (this may be named a dedicated resource allocation scheme). A target terminal performs a periodic transmission 1111 of an S-PRS to a neighboring terminal through a sidelink, and a terminal having received the S-PRS is a terminal able to serve as a measurement source, and may measure a TOA by using the received S-PRS. Next, the terminal able to serve as a measurement source may also perform a periodic transmission 1112 of an S-PRS, and the target terminal having received the S-PRS may measure a TOA by using the received S-PRS. When the target terminal and the terminal able to serve as a measurement source periodically transmit the S-PRSs 1111 and 1112, other pieces of positioning-related information may be provided together with the S-PRSs. In the disclosure, the corresponding information is not limited to only particular information. An example of the positioning-related information provided through the S-PRSs 1111 and 1112 may be location information (a known location) on a measurement source. The location information may be indicated through SCI (1st stage SCI or 2nd stage SCI), transmitted through a PSSCH, or indicated through PC5-RRC or a sidelink MAC-CE. Another example of the positioning-related information provided through the S-PRSs 1111 and 1112 may be reliability information proposed in the first embodiment. The reliability information may be indicated through SCI (1st stage SCI or 2nd stage SCI), transmitted through a PSSCH, or indicated through PC5-RRC or a sidelink MAC-CE. Another example of the positioning-related information provided through the Ack 1112 may be RX-TX time difference information 1113. The RX-TX time difference information may be indicated through SCI (1st stage SCI or 2nd stage SCI), transmitted through a PSSCH, or indicated through PC5-RRC or a sidelink MAC-CE.

Next, a method for calculating location information on a terminal by using an RTT and a multi-RTT through a positioning procedure proposed in FIGS. 11A and 11B will be described. First, an RTT may be defined to measure a time of flight (TOF) in Equation 1. Equation 1 below shows a ToF measured between a target terminal and a terminal able to be an m-th measurement source among the m measurement sources (m=0, 1, . . . , M−1) when terminals able to serve as M measurement sources exist around the target terminal.

$$ToF ( m ) = \frac{( {r}_{s o}^{T O A} ( m ) - {r}_{t a}^{T O D} ( m ) ) - ( {r}_{s o}^{T O D} ( m ) - {r}_{t a}^{T O A} ( m ) )}{2} , \qquad [ Equation 1 ]$$

In Equation 1, tₜₐ^{TOA} is a TOA value measured by the terminal able to be a measurement source by using an S-PRS transmitted by the target terminal, and tₛₒ^{TOA} indicates a TOA value measured by the target terminal by using an S-PRS transmitted by the terminal able to be a measurement source. tₛₒ^{TOD} is a TOD value that is a time point at which the terminal able to be a measurement source transmits the S-PRS to the target terminal, and tₜₐ^{TOD} indicates a TOD value that is a time point at which the target terminal transmits the S-PRS to the terminal able to be a measurement source. In Equation 1, tₛₒ^{TOD}−tₜₐ^{TOA} indicates the RX-TX time difference information 1103 or 1113, and tₛₒ^{TOA}−tₜₐ^{TOD} indicates the TX-RX time difference information 1104 or 1114.

Normally, a TOA may be obtained by taking correlation to a received signal and an S-PRS signal as in Equation 2.

$${R}_{m} ( t ) = {\sum }_{l = 0}^{{N}_{symb} - 1} {\sum }_{k = 0}^{{N}_{s c} - 1} {y}_{l , m} ( k + t ) {s}_{l , m}^{*} ( k ) , \qquad [ Equation 2 ]$$

In Equation 2, y_{l,m}(k) shows a signal received from an m-th measurement source on a k-th carrier and a first OFDM symbol, and s_{l,m}(k) shows an S-PRS signal. When a channel between terminals is one path (only a line of sight (LOS) exists), a temporal location at which Equation 2 is maximum/peak may be measured as a TOA. However, a channel between terminal s is normally configured by a multi-path, and a first path is not a path showing the strongest signal. Therefore, use of only Equation 2 may cause a measurement of an incorrect TOA. Therefore, a TOA may be measured through Equation 3 below.

$${t}_{s o}^{T O A} ( m ) = {min}_{{t}_{0} ( m ) - W \leq t \leq {t}_{0} ( m )} \{ t \} s . t . E \{ {\vert {R}_{m} ( t ) \vert}^{2} \} \geq {γ}_{th} , \qquad [ Equation 3 ]$$

In Equation 3,

$${t}_{0} ( m ) = {argmax}_{t} {\vert {R}_{m} ( t ) \vert}^{2}$$

may be defined, and W indicates the size of a search window. γₜₕ indicates a parameter configured as a threshold point for E{|Rₘ(t)|²}.

Reliability information provided to a target terminal by a terminal serving as a measurement source through a sidelink may be determined by a combination of conditions as described below. However, the disclosure is not limited to only the following conditions.
Condition 1: Reliability of location information (a known location) on a measurement source: When the reliability is low, the accuracy of relative and absolute positioning may become lower.
Condition 2: Movement of a terminal serving as a measurement source: When the terminal moves in a direction opposite to a target terminal at a high speed, a distance grows farther, the positioning accuracy may become lower.
Condition 3: Determination by sidelink reception power between a terminal serving as a measurement source and a target terminal: The smaller the reception power is, the lower the positioning accuracy may be.
Condition 4: Determination through line of sight (LOS)/non line-of-sight (NLOS) identification of a sidelink channel between a terminal serving as a measurement source and a target terminal: The closer the channel is to an LOS channel, the higher the positioning accuracy may be, and the closer the channel is to an NLOS channel, the lower the positioning accuracy may be.

As described in the first embodiment, when a terminal serving as a measurement source provides reliability information to a target terminal through a sidelink, alternative 1 and alternative 2 may be considered. If a value corresponding to reliability is 0 or is smaller than a particular threshold point, a corresponding terminal may not perform S-PRS transmission. Specifically, FIG. 11A, a transmission corresponding to the Ack 1102 may not be performed. In addition, FIG. 11B, a transmission corresponding to the S-PRSs 1111 and 1112 may not be performed.

Next, a method in which a terminal serving as a measurement source provides reliability information to a target terminal through a sidelink, and the target terminal selects a reliable measurement source by using the corresponding information, is proposed through Equation 4. In a case where a terminal serving as an m-th measurement source provides reliability information R(m), a ToF(m) value calculated by Equation 1 may be aligned in the order of the largest R(m) to the smallest. Thereafter, only a ToF(m) value satisfying R(m)≥Rₜₕ as in Equation 4 below may be selected to configure a set C.

C:=ToF(m)ϵC,s.t.R(m)≥Rₜₕ and m≤N, [Equation 4]

In Equation 4, N indicates the number of measurement sources used in positioning. Rₜₕ indicates a parameter configured as a threshold point for reliability. When a target terminal performs ranging, ranging (distance) may be measured by multiplying a ToF calculated from one measurement source by the velocity of light. When a target terminal performs relative positioning, angle information from a measurement source may be additionally measured, and relative positioning may be measured from a ranging measurement result and location information on the measurement source. When a target terminal performs absolute positioning, absolute positioning may be measured using ToFs calculated from multiple measurement sources. Therefore, when absolute positioning is performed using an RTT, multiple ToFs are needed in Equation 1, and thus a multi-RTT may be named. There are multiple algorithms for measuring absolute positioning by using multiple measurement sources, and a least square (LS) algorithm or an algorithm such as Taylor series may be used.

If N for absolute positioning is not ensured through Equation 4, a target terminal may not perform absolute positioning, and only perform relative positioning or ranging. In other words, according to Equation 4, a target terminal may apply different positioning methods according to the number of measurement sources available for positioning in a sidelink, and the quality of the measurement sources. For example, even when a target terminal is configured to perform absolute positioning through a higher configuration of a sidelink, the target terminal may perform only relative positioning or ranging according to the number of measurement sources available for actual sidelink positioning, and the quality of the measurement sources. On the contrary, even when a target terminal is configured to perform relative positioning through a higher configuration of a sidelink, the target terminal may perform absolute positioning according to the number of measurement sources available for actual sidelink positioning, and the quality of the measurement sources.

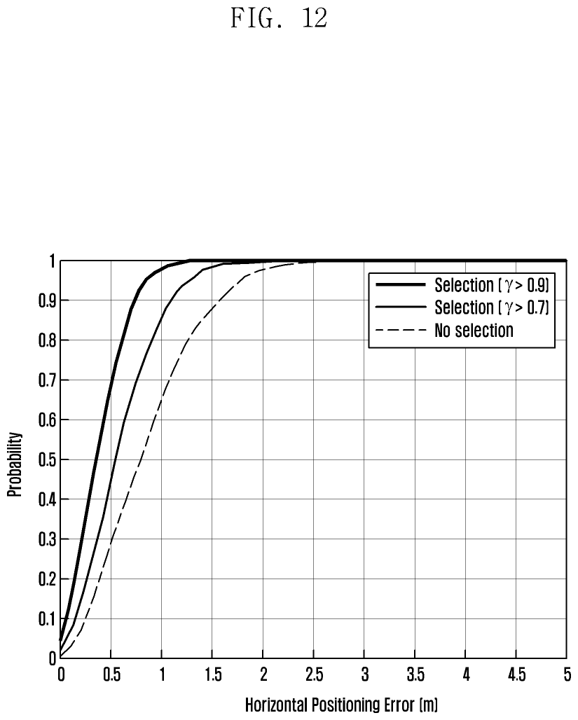

FIG. 12 illustrates a diagram of, through an experiment result, a performance when a terminal serving as a measurement source provides reliability information to a target terminal through a sidelink, and the target terminal selects a reliable measurement source by using the corresponding information, and performs positioning. Specifically, when the number of measurement sources is 8 (M=8), a performance of a case where a target terminal does not select a measurement source and performs absolute positioning by using all the M measurement sources (M=8), a performance of a case of selecting a measurement source having a threshold point for reliability, which is 0.7 or higher, according to application of Equation 4 and a performance of a case of selecting a measurement source having a threshold point for reliability, which is 0.9 or higher, are compared. From the experiment result illustrated in FIG. 12, it may be noted that selecting a reliable measurement source when positioning is performed in a sidelink is a very important factor to improve the accuracy of the positioning.

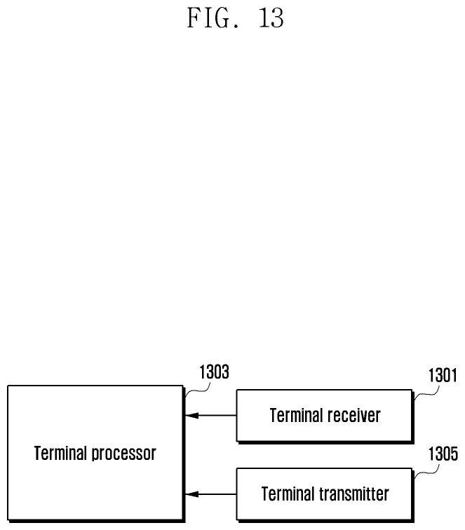

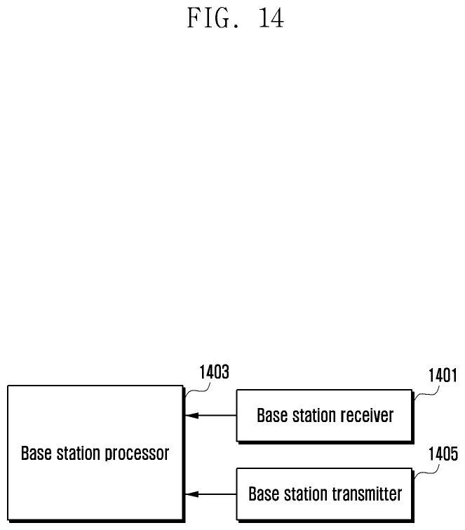

FIGS. 13 and 14 illustrate transmitters, receivers, and processors of a terminal and a base station to perform the above embodiments, respectively. The above embodiments shows a method for performing positioning in a sidelink by a terminal, and in order to perform the method, the receivers, the processors, and the transmitters of the terminal and the base station are needed to operate according to the embodiments.

Specifically, FIG. 13 illustrates a block diagram showing an internal structure of a terminal according to an embodiment. As illustrated in FIG. 13, a terminal of the disclosure may include a terminal receiver 1301, a terminal transmitter 1305, and a terminal processor 1303. The terminal receiver 1301 and the terminal transmitter 1305 may be collectively referred to as a transceiver in an embodiment. The transceiver may transmit or receive a signal to or from a base station. The signal may include control information and data. To this end, the transceiver may include an RF transmitter that up-converts and amplifies a frequency of a transmitted signal, an RF receiver that low-noise amplifies a received signal and down-converts the frequency, and the like. In addition, the transceiver may receive a signal through a wireless channel and output the signal to the terminal processor 1303, and may transmit a signal output from the terminal processor 1303, through a wireless channel. The terminal processor 1303 may control a series of processes so that the terminal operates according to an embodiment described above.

FIG. 14 illustrates a block diagram showing an internal structure of a base station according to an embodiment. As illustrated in FIG. 14, a base station of the disclosure may include a base station receiver 1401, a base station transmitter 1405, and a base station processor 1403. The base station receiver 1401 and the base station transmitter 1405 may be collectively referred to as a transceiver in an embodiment. The transceiver may transmit or receive a signal to or from a terminal. The signal may include control information and data. To this end, the transceiver may include an RF transmitter that up-converts and amplifies a frequency of a transmitted signal, an RF receiver that low-noise amplifies a received signal and down-converts the frequency, and the like. In addition, the transceiver may receive a signal through a wireless channel and output the signal to the base station processor 1403, and may transmit a signal output from the base station processor 1403, through a wireless channel. The base station processor 1403 may control a series of processes so that the base station operates according to embodiments described above.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, all the embodiment of the disclosure may be partially combined to operate a base station and a terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first terminal in a wireless communication system supporting sidelink, the method comprising:
receiving, from at least one second terminal, location information of the second terminal and reliability information for the location information of the second terminal;
selecting, at least one second terminal to be used for a location measurement of the first terminal based on the reliability information; and
determining, a location of the first terminal based on the location information of at least one second terminal selected based on the reliability information.

2. The method of claim 1, wherein the reliability information is generated by the second terminal based on at least one of a speed of the second terminal, a sidelink reception power between the first terminal and the second terminal or a non line-of-sight (NLOS) identification of a sidelink channel between the first terminal and the second terminal.

3. The method of claim 1, wherein the first terminal is configured with a threshold of the reliability information through pre-configuration.

4. The method of claim 1, wherein determining the location of the first terminal comprises:
determining a relative position of the first terminal based on the location information of at least one selected second terminal, in case that a number of selected second terminals is less than a number of second terminals needed to measure an absolute position of the first terminal.

5. The method of claim 1, wherein the reliability information is transmitted through sidelink control information (SCI) transmitted from a physical sidelink shared channel (PSSCH) or transmitted through a medium access control (MAC) control element (CE).

6. A first terminal in a wireless communication system supporting sidelink, the first terminal comprising:
a transceiver for transmitting and receiving a signal; and
a controller configured to:
receive, from at least one second terminal via the transceiver, location information of the second terminal and reliability information for the location information of the second terminal,
select, at least one second terminal to be used for a location measurement of the first terminal based on the reliability information; and
determine, a location of the first terminal based on the location information of at least one second terminal selected based on the reliability information.

7. The first terminal of claim 6, wherein the reliability information is generated by the second terminal based on at least one of a speed of the second terminal, a sidelink reception power between the first terminal and the second terminal or a non line-of-sight (NLOS) identification of a sidelink channel between the first terminal and the second terminal.

8. The first terminal of claim 6, wherein the first terminal is configured with a threshold of the reliability information through pre-configuration.

9. The first terminal of claim 6, wherein the controller is further configured to:
determine a relative position of the first terminal based on the location information of at least one selected second terminal, in case that a number of selected second terminals is less than a number of second terminals needed to measure an absolute position of the first terminal.

10. The first terminal of claim 6, wherein the reliability information is transmitted through sidelink control information (SCI) transmitted from a physical sidelink shared channel (PSSCH) or transmitted through a medium access control (MAC) control element (CE).

11. A method performed by a second terminal in a wireless communication system supporting sidelink, the method comprising:
generating, reliability information for location information of the second terminal; and
transmitting, to a first terminal, the location information of the second terminal and the reliability information.

12. The method of claim 11, wherein the reliability information is generated by the second terminal based on at least one of a speed of the second terminal, a sidelink reception power between the first terminal and the second terminal or a non line-of-sight (NLOS) identification of a sidelink channel between the first terminal and the second terminal.

13. The method of claim 11, wherein the reliability information is transmitted through sidelink control information (SCI) transmitted from a physical sidelink shared channel (PSSCH) or transmitted through a medium access control (MAC) control element (CE).

14. A second terminal in a wireless communication system supporting sidelink, the second terminal comprising:
a transceiver for transmitting and receiving a signal; and
a controller configured to:
generate, reliability information for location information of the second terminal; and
transmit, to a first terminal via the transceiver, the location information of the second terminal and the reliability information.

15. The second terminal of claim 14, wherein the reliability information is generated by the second terminal based on at least one of a speed of the second terminal, a sidelink reception power between the first terminal and the second terminal or a non line-of-sight (NLOS) identification of a sidelink channel between the first terminal and the second terminal.

16. The second terminal of claim 14, wherein the reliability information is transmitted through sidelink control information (SCI) transmitted from a physical sidelink shared channel (PSSCH) or transmitted through a medium access control (MAC) control element (CE).
